(19) United States
(12) Patent Application Publication
(10) Pub. No.: US 2011/0200511 A1
(43) Pub. Date: Aug. 18, 2011

(54) PROCESS FOR THE HYDROGENATION OF CHLOROSILANES AND CONVERTER FOR CARRYING OUT THE PROCESS

(75) Inventor: MATTEO BRANZI, Burgkirchen an der Alz (DE)

(73) Assignee: CENTROTHERM SITEC GMBH, Blaubeuren (DE)

(21) Appl. No.: 13/026,428

(22) Filed: Feb. 14, 2011

Related U.S. Application Data
(60) Provisional application No. 61/320,050, filed on Apr. 1, 2010.

(30) Foreign Application Priority Data
Feb. 12, 2010 (DE) 10 2010 007 916.2

(51) Int. Cl. C01B 33/107; B01J 19/00

(52) U.S. Cl. 423/342; 422/198

(57) ABSTRACT

In a process for the hydrogenation of chlorosilanes, a gas mixture of a chlorosilane gas to be hydrogenated and hydrogen gas is heated in a reactor to temperatures in the range between 500° C. and 1800° C. The chlorosilane gas is thereby at least partially hydrogenated. The reactor is heated by way of at least one flame from a fire box surrounding the reactor for the purpose of heating the gas mixture.

### CROSS-REFERENCE TO RELATED APPLICATION

This application claims the priority, under 35 U.S.C. §119, of German patent application DE 10 2010 007 916.2, filed Feb. 12, 2010; this application also claims the priority, under 35 U.S.C. §119(e), of provisional patent application No. 61/320,050, filed Apr. 1, 2010; the prior applications are herewith incorporated by reference in their entirety.

### BACKGROUND OF THE INVENTION

### Field of the Invention

The invention relates to a process for the hydrogenation of chlorosilanes and to a converter for carrying out the process. In the hydrogenation process a gas mixture comprising a chlorosilane gas to be hydrogenated and hydrogen gas is heated in a reactor to temperatures in the range between 500° C. and 1800° C. and the chlorosilane gas is thereby at least partially hydrogenated. A converter for carrying out the process includes at least one reactor, through which a flow can pass, and an inert layer, which is arranged on an inner wall of the reactor and is chemically inert toward chlorosilanes, hydrogen and hydrogen chloride.

Silicon tetrachloride is hydrogenated, in particular, in conjunction with the production of silicon. During the hydrogenation of the silicon tetrachloride, chlorosilanes which are additionally present may partially be likewise hydrogenated, such that corresponding processes can also be used, in principle, specifically for the hydrogenation of chlorosilanes. It may then be necessary to appropriately adapt the process parameters. Owing to this similarity between silicon tetrachloride and chlorosilanes, silicon tetrachloride is sometimes incorrectly also referred to as tetrachlorosilane and therefore assigned to the group of chlorosilanes. Although the correct term (silicon tetrachloride) is used in the present application, silicon tetrachloride is regarded as chlorosilane within the context of the present invention. Where reference is made in the present case to chlorosilanes, this expressly includes silicon tetrachloride.

At present, silicon is produced for the most part by means of chemical vapor deposition using the so-called Siemens process. In that process, silicon originating from trichlorosilane gas is deposited on a silicon seed. During such a deposition, large quantities of silicon tetrachloride are produced owing to secondary reactions. It is therefore desirable to convert this silicon tetrachloride by hydrogenation back into trichlorosilane, which can then in turn be fed to the silicon deposition process.

It is known that the silicon tetrachloride can be converted into trichlorosilane in this way by thermal steady-state recycling at temperatures above about 600° C. A significant yield of trichlorosilane is thereby only established at temperatures of more than 900° C. Reactors, or converters, which are used therefor have to be able to withstand such temperatures. Since, furthermore, the intention is to avoid the ingress of impurities, which can have a negative effect on semiconductor elements produced from the silicon thus obtained, components which come into contact with reactants or reaction products are produced from graphite in the prior art (cf. for example German published patent application DE 30 24 319 A1). Furthermore, the use of carbon fiber composite material is described in U.S. Pat. No. 5,906,799 and its counterpart German patent DE 43 17 905 C2. To further improve the chemical resistance of these components to starting materials and products which arise during the conversion, it is additionally known to provide the walls of the components produced from carbon or graphite with a silicon carbide layer in situ.

Since the graphite which is used has an ignition temperature of about 600° C., and the other carbon materials used in the prior art are also at risk of igniting at the temperatures which prevail, these are heated electrically under an oxygen-free protective gas atmosphere in the prior art.

### SUMMARY OF THE INVENTION

It is accordingly an object of the invention to provide a process and a converter for hydrogenating chlorosilanes which overcome the above-mentioned disadvantages of the heretofore-known devices and methods of this general type and which provides for an inexpensive process for the hydrogenation of silicon tetrachloride or chlorosilanes.

With the foregoing and other objects in view there is provided, in accordance with the invention, a process for hydrogenating chlorosilanes, the method which comprises:

feeding a gas mixture of chlorosilane gas to be hydrogenated and hydrogen gas into a reactor;

heating the reactor by way of at least one flame in a region surrounding the reactor and thereby heating the gas mixture to temperatures in a range between 500° C. and 1800° C.; and

thereby at least partially hydroginating the chlorosilane gas.

There is also provided, in accordance with the invention, a converter for carrying out the process. The converter comprising:

at least one reactor configured for conducting a flow passing therethrough;

said at least one reactor having an inner wall carrying an inert layer, said inert layer being chemically inert toward chlorosilanes, hydrogen, and hydrogen chloride;

said at least one reactor having an outer wall being refractory up to a temperature of at least 1800° C.;

a firebox enclosing said at least one reactor at least partially;

at least one flame source disposed in said firebox outside said reactor.

In the process according to the invention for the hydrogenation of chlorosilanes, a gas mixture comprising a chlorosilane gas to be hydrogenated and hydrogen gas is heated in a reactor to temperatures in a range between 500° C. and 1800° C. and the chlorosilane gas is thereby at least partially hydrogenated. The basic concept of the process according to the invention is that of heating the reactor by means of at least one flame arranged in an area surrounding the reactor for the purpose of heating the gas mixture. In the present case, a flame is to be understood as meaning an open flame of fire, as can be produced, for example, by burning fossil fuels. In this way, the reactor can be heated with primary energy sources such as gas or oil rather than with exegetically high-quality flow, and therefore the outlay for carrying out the process is reduced. Since the flame is formed by burning the primary energy source with the supply of oxygen, it is additionally possible to dispense with the provision of protective gas atmospheres common to date, and this represents a further reduction in outlay.

To date, it has been assumed that reactions which proceed during the hydrogenation of chlorosilanes are uncontrollable when heating by means of flames, and therefore electrical heating was chosen for safety reasons. However, it has surprisingly been found that the reactions which proceed are sufficiently controllable in the process according to the invention, in particular when a suitable converter is used. Furthermore, it has been found that it is possible to hydrogenate chlorosilanes by the process according to the invention without there being an increased ingress of impurities into the reaction products compared to known, commercial processes.

In practice, it has proved to be expedient when a pressure in the range of 1 to 50 bar prevails in the reactor as the process is being carried out.

In a preferred embodiment variant of the process according to the invention, silicon tetrachloride is hydrogenated to form trichlorosilane. In principle, it is of course also possible to hydrogenate other chlorosilanes as silicon tetrachloride.

In a development of the process according to the invention, reaction products formed during the hydrogenation are cooled to a temperature of less than 700° C., preferably to a temperature of less than 300° C., within a period of time of less than one second. It is thereby possible to increase the conversion efficiency, i.e. the proportion of hydrogenated chlorosilane gas in the reaction products after the latter have been cooled. The reaction products are advantageously cooled to a temperature of less than 700° C., or of less than 300° C., within said period of time by virtue of the admixture of liquid silicon tetrachloride.

In an advantageous embodiment variant of the process according to the invention, the heat from the reaction products is recovered, preferably via a heat exchanger. It has proved to be expedient to use the recovered heat to preheat the chlorosilane gas and/or the hydrogen in the gas mixture or to preheat combustion air. In this case, combustion air is to be understood in principle as meaning any desired oxygen-containing gas mixture, the oxygen content of which is used to form the at least one flame. The recovered heat is preferably used to preheat the chlorosilane gas to be hydrogenated and the admixed hydrogen.

It has been found that, when using a converter according to the invention as described below, it is possible to hydrogenate chlorosilanes by the process according to the invention without there being a greater ingress of impurities than in processes according to the prior art, which provide in-situ coating of the reactor walls with silicon carbide. In this case, however, it is possible to dispense with in-situ coating with silicon carbide, and therefore the associated increased heating of the reactor is no longer necessary. This represents a further reduction in outlay.

The converter according to the invention for carrying out the process according to the invention comprises at least one reactor, through which flow can pass, and an inert layer, which is arranged on an inner wall of the reactor and is chemically inert toward chlorosilanes, hydrogen and hydrogen chloride. A firebox, in which the at least one reactor is arranged at least in part, is also provided. At least one flame source is arranged outside the reactor. Furthermore, an outer wall of the reactor is refractory up to a temperature of at least 1800° C.

Within the context of the present invention, a reactor through which flow can pass is to be understood as meaning a reactor through which the gas mixture introduced into it, or the products formed as the process is being carried out, can flow. Within the context of the present invention, an outer wall of the reactor is refractory if it is dimensionally stable up to said temperature and cannot be ignited in an oxygen-containing atmosphere.

In an embodiment variant of the converter according to the invention, the reactor is produced from an element from the group consisting of platinum, palladium, rhenium, iridium, platinum alloys, palladium alloys, rhenium alloys and also iridium alloys. The inert layer is additionally formed from reactor material, i.e. it consists of the element selected from said group. The reactor is preferably produced from platinum or a platinum alloy, and therefore the inert layer in this case consists of platinum or the platinum alloy.

In an alternative embodiment variant of the converter according to the invention, the reactor is produced from a ceramic material, preferably from aluminum oxide or silicon oxide. In principle, it is also conceivable to use silicon carbide as the ceramic material. Silicon carbide deposited in situ, as is used to some extent in the prior art described in the introduction, is not suitable, however, since the layer thicknesses thereby obtained are too small. Instead, use should be made of densely compressed silicon carbide. However, at present it is not technologically possible to produce reactors from densely compressed silicon carbide with a sufficient length. In this context, it should be pointed out that reactors having a greater length are required for carrying out the process according to the invention than in processes which provide electrical heating of the gas mixture or of the reactor conducting the gas mixture. The described elongation of the reactor makes it possible to reliably distribute the material stresses, which arise owing to a prevailing temperature gradient, over the length of the reactor. By contrast, electrical heating makes improved adjustability of the temperature gradient and therefore shorter reactors possible.

According to a further alternative embodiment variant of the converter according to the invention, the reactor is produced by a centrifugal casting process from stainless steel and the inner wall of the reactor is lined with a material which is chemically inert toward chlorosilanes, hydrogen and hydrogen chloride. Since the reactor is produced by the centrifugal casting process from stainless steel, the resultant stainless steel is able to withstand high temperatures and is therefore refractory within the context of the present invention. It is preferable for the reactor to have a tubular form and to be lined with a tubular inert material, for example a platinum tube.

According to a development, the inner wall is lined with an element from the group consisting of platinum, palladium, rhenium, iridium, platinum alloys, palladium alloys, rhenium alloys and iridium alloys. The inner wall is preferably lined with platinum or a platinum alloy.

In an alternative embodiment variant, the inner wall is lined with a ceramic material, preferably with aluminum oxide or silicon oxide. As already mentioned above, it is also possible in principle to use silicon carbide as the ceramic material, provided that it can be made available in the future in a sufficient quality and with an adequate length. At present, however, this is not the case.

In an advantageous embodiment variant of the converter according to the invention, at least one reactor is formed as a tube having a length of at least 7 m. Stresses which arise in the tube owing to the temperature gradient prevailing along the tube can thereby be distributed sufficiently over the length thereof. In this case, the tube preferably has a diameter in a range of 10 mm to 50 mm and particularly preferably a diameter in a range of 10 mm to 30 mm.

In the case of the converter according to the invention, it has proved to be advantageous to provide a plurality of reactors formed as tubes. The reactors are preferably oriented parallel to one another.

Other features which are considered as characteristic for the invention are set forth in the appended claims.

Although the invention is illustrated and described herein as embodied in a process for the hydrogenation of chlorosilanes and converter for carrying out the process, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic sectional illustration of an exemplary embodiment of the process according to the invention and of an exemplary embodiment of the converter according to the invention;

FIG. 2 is a schematic sectional illustration through a reactor of a further exemplary embodiment of the converter according to the invention; and

FIG. 3 is a schematic sectional illustration of a reactor of a further exemplary embodiment of the converter according to the invention.

### DETAILED DESCRIPTION OF THE INVENTION

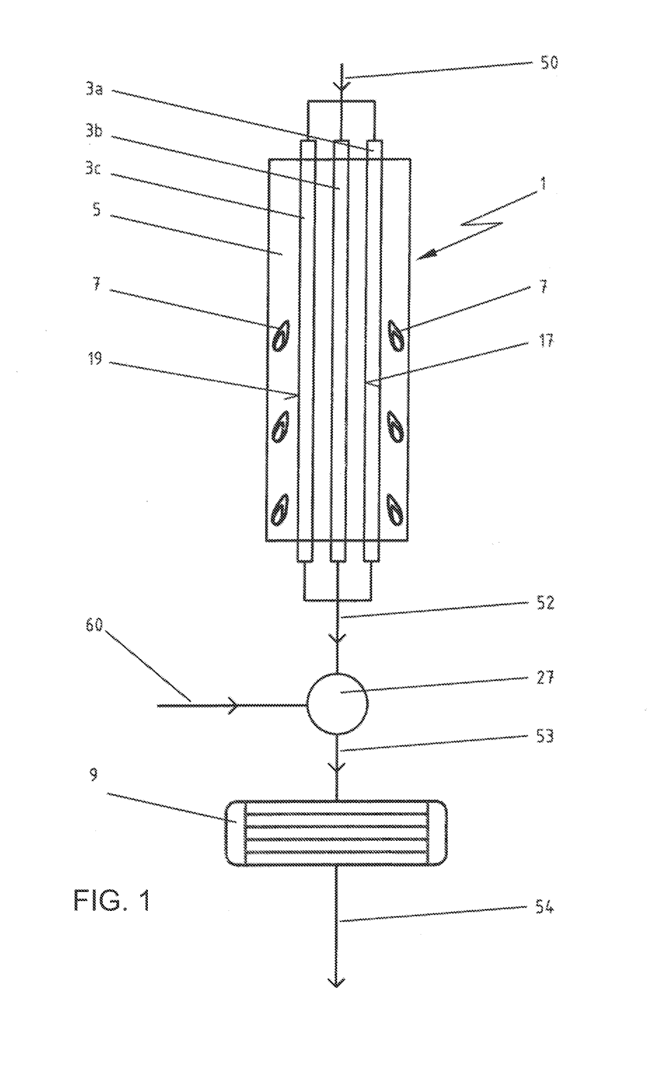

Referring now to the figures of the drawing in detail and first, particularly, to FIG. 1 thereof, there is shown a schematic outline illustration of a converter according to the invention. A first exemplary embodiment of the novel process will be described with reference to the illustrated converter 1. The converter 1 comprises a firebox 5, which, by way of example, can be produced from stainless steel that is able to withstand high temperatures. The illustrated converter 1 has three reactors 3a, 3b, 3c, through which a starting material stream 50 can pass. In the exemplary embodiment shown in FIG. 1, the reactors 3a, 3b, 3c are formed as platinum tubes. It is also possible to provide palladium, rhenium or iridium or alloys of said metals as the material instead of platinum.

The tubular reactors 3a, 3b, 3c are oriented parallel to one another in the firebox 5. The reactors 3a, 3b, 3c, and therefore starting materials located in the reactors 3a, 3b, 3c, are heated in the firebox 5 by way of flame sources 7. Such flame sources 7 can be formed, for example, by gas or oil nozzles. The flame sources 7 are arranged so as to be distributed in the firebox outside the reactors 3a, 3b, 3c, which is merely indicated schematically in FIG. 1. In practice, lengths of at least 7 m and diameters in the range of 10 mm to 30 mm have proved to be expedient for the reactors 3a, 3b, 3c.

In the exemplary embodiment shown in FIG. 1, the inert layer arranged on the inner walls 17 of the reactors 3a, 3b, 3c is formed by the reactor itself, since platinum is chemically inert toward chlorosilanes, hydrogen and hydrogen chloride. Furthermore, platinum is refractory within the context of the present invention, and therefore this also applies to outer walls 19 of the reactors 3a, 3b, 3c.

As illustrated schematically in FIG. 1, the converter 1 according to the invention can be used to carry out an illustrated exemplary embodiment of the process according to the invention. In this case, a starting material stream 50, which represents a gas mixture comprising silicon tetrachloride gas to be hydrogenated and hydrogen gas, is fed into the reactors 3a, 3b, 3c. This is indicated schematically by an arrow in FIG. 1 at the header of the converter 1. In the converter 1, the constituents of the starting material stream 50 are heated to temperatures in the range between 500° C. and 1800° C. by way of flames originating from the flame sources 7. In this case, the silicon tetrachloride gas present in the starting material stream 50 is partially hydrogenated to form trichlorosilane, which is likewise gaseous. Since the flame sources 7 are arranged outside the reactors 3a, 3b, 3c, as described above, the flames originating from the flame sources 7 are also located outside the reactors 3a, 3b, 3c and therefore in the area surrounding the latter.

The starting material stream 50 is preferably fed into the reactors 3a, 3b, 3c at a pressure in a range between 1 and 50 bar. In the course of the partial conversion of the silicon tetrachloride in the converter 1, a hot product stream 52 containing, inter alia, the trichlorosilane obtained is produced from the starting material stream 50. In addition, the hot product stream 52 contains non-hydrogenated silicon tetrachloride, hydrogen and hydrogen chloride. The hot product stream 52 emerges from the reactors 3a, 3b, 3c at a bottom end of the converter 1 and is then cooled. Here, the hot product stream 52 is advantageously cooled to a temperature of less than 700° C. within a period of time of less than one second. This preferably takes place by quenching of the hot product stream 52 with liquid silicon tetrachloride 60, which is admixed to the hot product stream 52. As illustrated schematically in FIG. 1, this can be done using a quench pot 27 known per se, for example. The hot product stream 52 is particularly preferably cooled to a temperature of less than 300° C. within said period of time. The result is a precooled product stream 53 containing, inter alia, the trichlorosilane obtained by hydrogenation.

The product stream 53, which is precooled by quenching, is then fed to a heat exchanger 9, in which residual heat is taken from the precooled product stream 53, such that a cold product stream 54 is present as a result. The heat recovered by means of the heat exchanger 9 is preferably used to preheat the starting material stream 50 before it is fed into the reactors 3a, 3b, 3c. Alternatively, or in addition, provision may be made to use the recovered heat to preheat combustion air fed to the firebox 5 for the purpose of forming flames. This feeding operation is not shown in FIG. 1 for reasons of clarity.

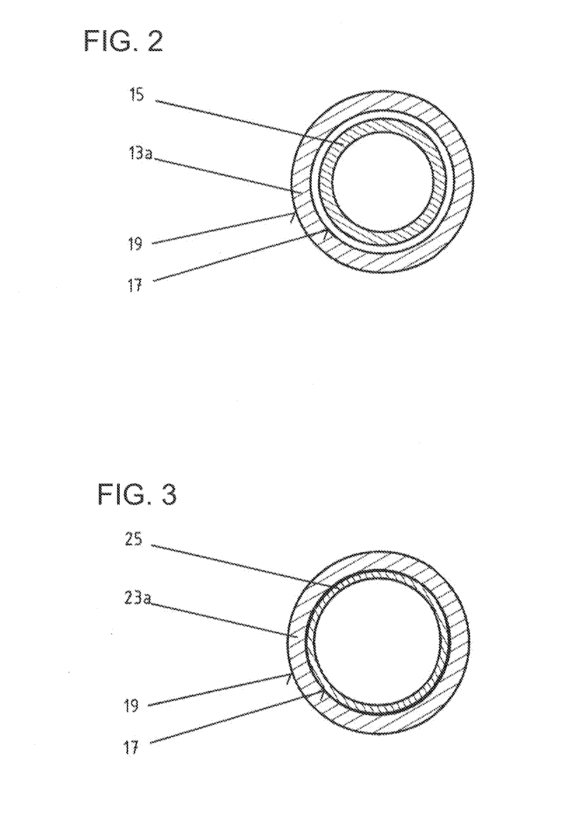

FIG. 2 is a schematic illustration showing a section through a reactor 13a of a further exemplary embodiment of the converter according to the invention. Such a reactor 13a can be used in the converter 1 shown in FIG. 1, for example, instead of one or a plurality of the reactors 3a, 3b, 3c. The reactor 13a shown in FIG. 2 is produced by a centrifugal casting process from stainless steel which, owing to this special casting process, is able to withstand high temperatures and is refractory within the context of the present invention. An inner wall 17 of the reactor 13a is lined with a material which is chemically inert toward chlorosilanes, hydrogen and hydrogen chloride. In the case of FIG. 2, this lining is realized by means of a platinum tube 15, which is arranged in the tubular reactor 13a and therefore lines it. Since the platinum tube 15 is not assigned a load-bearing property, it can be formed with comparatively thin walls. Instead of the platinum tube 15, it is also possible, for example, to provide an iridium tube or a palladium tube. A tube made of a ceramic material, for example aluminum oxide or silicon oxide, is also conceivable in principle.

In the exemplary embodiment shown in FIG. 2, an outer wall 19 of the reactor 13a is formed from the stainless steel which is able to withstand high temperatures and is produced by a centrifugal casting process, and is therefore refractory within the context of the present invention.

FIG. 3 is an outline illustration showing a section through a reactor 23a of a further exemplary embodiment of the converter according to the invention. This converter can be formed, for example, by providing the reactor 23a instead of one or a plurality of the reactors 3a, 3b, 3c in FIG. 1. In a manner corresponding to the reactor 13a shown in FIG. 2, the reactor 23a is produced by a centrifugal casting process from stainless steel, and therefore the outer wall 19 of said reactor in turn is refractory within the context of the present invention. A ceramic lining 25 is provided on the inner wall 17 of the reactor 23a. The ceramic lining is formed by coating the inner wall 17 with a ceramic, for example aluminum oxide or silicon oxide. The ceramic lining 25 therefore represents the inert layer arranged on the inner wall 17 of the reactor 23a.

The following list of reference numerals referenced in the figures and in the above description may aid the reader in an understanding of the invention:
1 Converter
3a Reactor
3b Reactor
3c Reactor
5 Firebox
7 Flame source
9 Heat exchanger
13a Reactor
15 Platinum tube
17 Inner wall
19 Outer wall
23a Reactor
25 Ceramic lining
27 Quench pot
50 Starting material stream
52 Hot product stream
53 Precooled product stream
54 Cold product stream
60 Liquid silicon tetrachloride

1. A process for hydrogenating chlorosilanes, the method which comprises:
feeding a gas mixture containing chlorosilane gas to be hydrogenated and hydrogen gas into a reactor;
heating the reactor by way of at least one flame in a region surrounding the reactor and thereby heating the gas mixture to temperatures in a range between 500° C. and 1800° C.; and
thereby at least partially hydroginating the chlorosilane gas.

2. The process according to claim 1, which comprises hydrogenating silicon tetrachloride to form trichlorosilane.

3. The process according to claim 1, which comprises cooling reaction products formed during the hydrogenation to a temperature of less than 700° C. within a time period of less than one second.

4. The process according to claim 3, wherein the cooling step comprises cooling the reaction products to less than 300° C. within less than one second.

5. A converter for carrying out the process according to claim 1, comprising:
at least one reactor configured for conducting a flow passing therethrough;
said at least one reactor having an inner wall carrying an inert layer, said inert layer being chemically inert toward chlorosilanes, hydrogen, and hydrogen chloride;
said at least one reactor having an outer wall being refractory up to a temperature of at least 1800° C.;
a firebox enclosing said at least one reactor at least partially;
at least one flame source disposed in said firebox outside said reactor.

6. A converter for hydrogenating chlorosilanes, comprising:
at least one reactor having an inlet for receiving a gas mixture containing chlorosilane gas to be hydrogenated and hydrogen gas and conducting a flow of the gas mixture therethrough;
said at least one reactor having an inner wall carrying an inert layer, said inert layer being chemically inert toward chlorosilanes, hydrogen, and hydrogen chloride;
said at least one reactor having an outer wall being refractory up to a temperature of at least 1800° C.;
a firebox containing said at least one reactor at least partially, and at least one flame source disposed in said firebox for heating said reactor from outside said reactor and thereby heating the gas mixture to temperatures in a range between 500° C. and 1800° C., to thereby at least partially hydrogenate the chlorosilane gas.

7. The converter according to claim 6, wherein said reactor is produced from a material selected from the group consisting of platinum, palladium, rhenium, iridium, platinum alloys, palladium alloys, rhenium alloys, and iridium alloys and said inert layer is formed from reactor material.

8. The converter according to claim 6, wherein said reactor is produced from platinum or a platinum alloy.

9. The converter according to claim 6, wherein said reactor is produced from a ceramic material.

10. The converter according to claim 6, wherein said reactor is produced from aluminum oxide or silicon oxide.

11. The converter according to claim 6, wherein said reactor is produced by a centrifugal casting process from stainless steel and said inner wall of said reactor is lined with a material that is chemically inert toward chlorosilanes, hydrogen and hydrogen chloride.

12. The converter according to claim 10, wherein said inner wall is lined with a material selected from the group consisting of platinum, palladium, rhenium, iridium, platinum alloys, palladium alloys, rhenium alloys, and iridium alloys.

13. The converter according to claim 10, wherein said inner wall is lined with platinum or a platinum alloy.

14. The converter according to claim 10, wherein said inner wall is lined with a ceramic material.

15. The converter according to claim 14, wherein said inner wall is lined with aluminum oxide or silicon oxide.

16. The converter according to claim 6, wherein at least one reactor is a tube having a length of at least 7 m.

17. The converter according to claim 6, wherein said tube has a diameter in a range of 10 mm to 50 mm.

18. The converter according to claim 6, wherein said tube has a diameter in a range of 10 mm to 30 mm.

19. The converter according to claim 6, wherein said at least one reactor is one of a plurality of reactors each formed as a tube.

20. The converter according to claim 19, wherein said tubes are disposed parallel to one another.
